(19) United States
(12) Patent Application Publication
(10) Pub. No.: US 2016/0234513 A1
(43) Pub. Date: Aug. 11, 2016

(54) DATA PROCESSING APPARATUS AND METHOD FOR COMPRESSED PIXEL DATA GROUPS

(71) Applicant: MEDIATEK INC., Hsin-Chu (TW)

(72) Inventors: Chi-Cheng Ju, Hsinchu City (TW); Tsu-Ming Liu, Hsinchu City (TW)

(73) Assignee: MEDIATEK INC., Hsin-Chu (TW)

(21) Appl. No.: 15/022,214

(22) PCT Filed: Oct. 16, 2014
(86) PCT No.: PCT/CN2014/088756

§ 371 Date: Mar. 16, 2016

Related U.S. Application Data
(60) Provisional application No. 61/892,227, filed on Oct. 17, 2013.

(51) Int. Cl. H04N 19/182; H04N 19/176; H04N 19/14; H04N 19/436; H04N 19/115

(52) U.S. Cl. CPC H04N 19/182; H04N 19/436; H04N 19/115; H04N 19/14; H04N 19/176

(57) ABSTRACT

A data processing apparatus includes a compression circuit and a first output interface. The compression circuit generates a plurality of compressed pixel data groups by compressing pixel data of a plurality of pixels of a picture based on a pixel data grouping setting of the picture, and generates indication information indicative of at least one boundary each between consecutive compressed pixel data groups. The first output interface packs the compressed pixel data groups into at least one output bitstream, and outputs the at least one output bitstream via a camera interface.

### CROSS REFERENCE TO RELATED APPLICATIONS

This application claims the benefit of U.S. provisional application No. 61/892,227, filed on Oct. 17, 2013 and incorporated herein by reference.

### FIELD OF INVENTION

The disclosed embodiments of the present invention relate to transmitting and receiving data over a camera interface, and more particularly, to a data processing apparatus for transmitting/receiving randomly accessible compressed pixel data groups and a related data processing method.

### BACKGROUND OF THE INVENTION

A camera interface is disposed between a first chip and a second chip to transmit multimedia data from the first chip to the second chip for further processing. For example, the first chip may include a camera module, and the second chip may include an image signal processor (ISP). The multimedia data may include image data (i.e., a single still image) or video data (i.e., a video sequence composed of successive images). When a camera sensor with a higher resolution is employed in the camera module, the multimedia data transmitted over the camera interface would have a larger data size/data rate, which increases the power consumption of the camera interface inevitably. If the camera module and the ISP are both located at a portable device (e.g., a smartphone) powered by a battery device, the battery life is shortened due to the increased power consumption of the camera interface. Thus, there is a need for an innovative design which can effectively reduce the power consumption of the camera interface.

### SUMMARY OF THE INVENTION

In accordance with exemplary embodiments of the present invention, a data processing apparatus for transmitting/receiving randomly accessible compressed pixel data groups and a related data processing method are proposed.

According to a first aspect of the present invention, an exemplary data processing apparatus is disclosed. The exemplary data processing apparatus includes a compression circuit and a first output interface. The compression circuit is configured to generate a plurality of compressed pixel data groups by compressing pixel data of a plurality of pixels of a picture based on a pixel data grouping setting of the picture, and generate indication information indicative of at least one boundary each between consecutive compressed pixel data groups. The first output interface is configured to pack the compressed pixel data groups into at least one output bitstream, and output the at least one output bitstream via a camera interface.

According to a second aspect of the present invention, an exemplary data processing apparatus is disclosed. The exemplary data processing apparatus includes a compression circuit, a rate controller, and an output interface. The compression circuit is configured to generate a plurality of compressed pixel data groups by compressing pixel data of a plurality of pixels of a picture based on a pixel data grouping setting of the picture. The rate controller is configured to perform bit rate control. The output interface is configured to pack the compressed pixel data groups into an output bitstream, and output the output bitstream via a camera interface. At least a portion of at least one of consecutive compressed pixel data groups is generated under a fixed compression ratio controlled by the rate controller.

According to a third aspect of the present invention, an exemplary data processing apparatus is disclosed. The exemplary data processing apparatus includes an input interface and a de-compressor. The input interface is configured to receive an input bitstream from a camera interface, un-pack the input bitstream into a plurality of compressed pixel data groups of a picture, and parse indication information included in the input bitstream, wherein the indication information is indicative of at least one boundary each between consecutive compressed pixel data groups packed in the input bitstream. The de-compressor is configured to refer to the indication information to select a compressed pixel data group from the compressed pixel data groups, and de-compress the compressed pixel data group to generate a de-compressed pixel data group.

According to a fourth aspect of the present invention, an exemplary data processing apparatus is disclosed. The exemplary data processing apparatus includes a first input interface, a second input interface, and a de-compressor. The first input interface is configured to receive an input bitstream from a camera interface, and un-pack the input bitstream into a plurality of compressed pixel data groups of a picture. The second input interface is configured to receive indication information from an out-of-band channel, wherein the indication information is indicative of at least one boundary each between consecutive compressed pixel data groups packed in the input bitstream. The de-compressor is configured to refer to the indication information to select a compressed pixel data group from the compressed pixel data groups, and de-compress the compressed pixel data group to generate a de-compressed pixel data group.

According to a fifth aspect of the present invention, an exemplary data processing apparatus is disclosed. The data processing apparatus includes an input interface and a de-compression circuit. The input interface is configured to receive an input bitstream from a camera interface, and un-pack the input bitstream into a plurality of compressed pixel data groups, wherein at least a portion of at least one of consecutive compressed pixel data groups packed in the input bitstream is generated under a fixed compression ratio. The de-compression circuit is configured to select a compressed pixel data group from the compressed pixel data groups according to at least the fixed compression ratio, and de-compress the compressed pixel data group to generate a de-compressed pixel data group.

According to a sixth aspect of the present invention, an exemplary data processing method is disclosed. The exemplary data processing method includes: generating a plurality of compressed pixel data groups by compressing pixel data of a plurality of pixels of a picture based on a pixel data grouping setting of the picture; generating indication information indicative of at least one boundary each between consecutive compressed pixel data groups; and packing the compressed pixel data groups into at least one output bitstream, and outputting the at least one output bitstream via a camera interface.

According to a seventh aspect of the present invention, an exemplary data processing method is disclosed. The exemplary data processing method includes: performing bit rate control; generating a plurality of compressed pixel data groups by compressing pixel data of a plurality of pixels of a picture based on a pixel data grouping setting of the picture; packing the compressed pixel data groups into an output bitstream, and outputting the output bitstream via a camera interface. At least a portion of at least one of consecutive compressed pixel data groups is generated under a fixed compression ratio controlled by the bit rate control.

According to an eighth aspect of the present invention, an exemplary data processing method is disclosed. The exemplary data processing method includes: receiving an input bitstream from a camera interface, un-packing the input bitstream into a plurality of compressed pixel data groups of a picture, and parsing indication information included in the input bitstream, wherein the indication information is indicative of at least one boundary each between consecutive compressed pixel data groups packed in the input bitstream; and referring to the indication information to select a compressed pixel data group from the compressed pixel data groups, and de-compressing the compressed pixel data group to generate a de-compressed pixel data group.

According to a ninth aspect of the present invention, an exemplary data processing method is disclosed. The exemplary data processing method includes: receiving an input bitstream from a camera interface, and un-packing the input bitstream into a plurality of compressed pixel data groups of a picture; receiving indication information from an out-of-band channel, wherein the indication information is indicative of at least one boundary each between consecutive compressed pixel data groups packed in the input bitstream; and referring to the indication information to select a compressed pixel data group from the compressed pixel data groups, and de-compressing the compressed pixel data group to generate a de-compressed pixel data group.

According to a tenth aspect of the present invention, an exemplary data processing method is disclosed. The exemplary data processing method includes: receiving an input bitstream from a camera interface, and un-packing the input bitstream into a plurality of compressed pixel data groups, wherein at least a portion of at least one of consecutive compressed pixel data groups packed in the input bitstream is generated under a fixed compression ratio; and selecting a compressed pixel data group from the compressed pixel data groups according to at least the fixed compression ratio, and de-compressing the compressed pixel data group to generate a de-compressed pixel data group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data processing system according to an embodiment of the present invention.

FIG. 2 is a diagram of a camera module shown in FIG. 1 according to an embodiment of the present invention.

FIG. 3 is a diagram of an image signal processor shown in FIG. 1 according to an embodiment of the present invention.

FIG. 4 is a diagram illustrating a first random access capability enhancement technique proposed by the present invention.

FIG. 5 is a diagram illustrating a second random access capability enhancement technique proposed by the present invention.

FIG. 6 is a diagram illustrating a third random access capability enhancement technique proposed by the present invention.

FIG. 7 is a flowchart illustrating one control and data flow of the data processing system shown in FIG. 1 according to an embodiment of the present invention.

FIG. 8 is a diagram illustrating a fourth random access capability enhancement technique proposed by the present invention.

FIG. 9 is a diagram illustrating a fifth random access capability enhancement technique proposed by the present invention.

FIG. 10 is a flowchart illustrating another control and data flow of the data processing system shown in FIG. 1 according to an embodiment of the present invention.

FIG. 11 is a diagram illustrating a sixth random access capability enhancement technique proposed by the present invention.

FIG. 12 is a diagram illustrating a seventh random access capability enhancement technique proposed by the present invention.

FIG. 13 is a flowchart illustrating yet another control and data flow of the data processing system shown in FIG. 1 according to an embodiment of the present invention.

FIG. 14 is a block diagram illustrating another data processing system according to an embodiment of the present invention.

FIG. 15 is a diagram of a camera module shown in FIG. 14 according to an embodiment of the present invention.

FIG. 16 is a diagram of an image signal processor shown in FIG. 14 according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention proposes applying data compression to a multimedia data and then transmitting a compressed multimedia data over a camera interface. As the data size/data rate of the compressed multimedia data is smaller than that of the original un-compressed multimedia data, the power consumption of the camera interface is reduced correspondingly. When a camera sensor with a higher resolution is used for image capture, a single image signal processor may require higher computing power for processing the multimedia data in time, and/or a single camera port of the camera interface may require a high transmission bandwidth. To alleviate the bandwidth requirement, multiple image signal processors may be used to process different image partitions of one picture in a parallel manner.

If the compressed multimedia data of one picture is transmitted from a camera module to the image signal processors via the camera interface, each of the image signal processors may have difficulty in randomly accessing the compressed multimedia data to obtain a desired compressed data portion. Specifically, in regard to generation of the compressed multimedia data, the rate control is employed to optimally or sub-optimally adjust the bit rate of each compression unit (e.g., X×Y pixels, where X may be 4 and Y may be 2) so as to achieve the content-aware bit budget allocation and therefore improve the visual quality. For example, variable-length coding (VLC) is commonly employed to achieve the desired bit-rate control. However, when the rate-controlled compression is employed for data size/data rate reduction, the random access capability for the compressed multimedia data suffers. As a result, when compressed data transmission over the camera interface is enabled, using multiple image signal processors to process different image partitions of one picture in a parallel manner cannot be easily realized due to lack of the random access capability for the compressed multimedia data. To solve this issue, the present invention therefore proposes several solutions each capable of making compressed pixel data groups randomly accessible to the image signal processors. Moreover, when the compressed data is dumped to a buffer before transmitted from the camera module to the image signal processors via the camera interface, the proposed solution may also be employed to make compressed pixel data groups randomly accessible to an output interface of the camera module. Further details will be described as below.

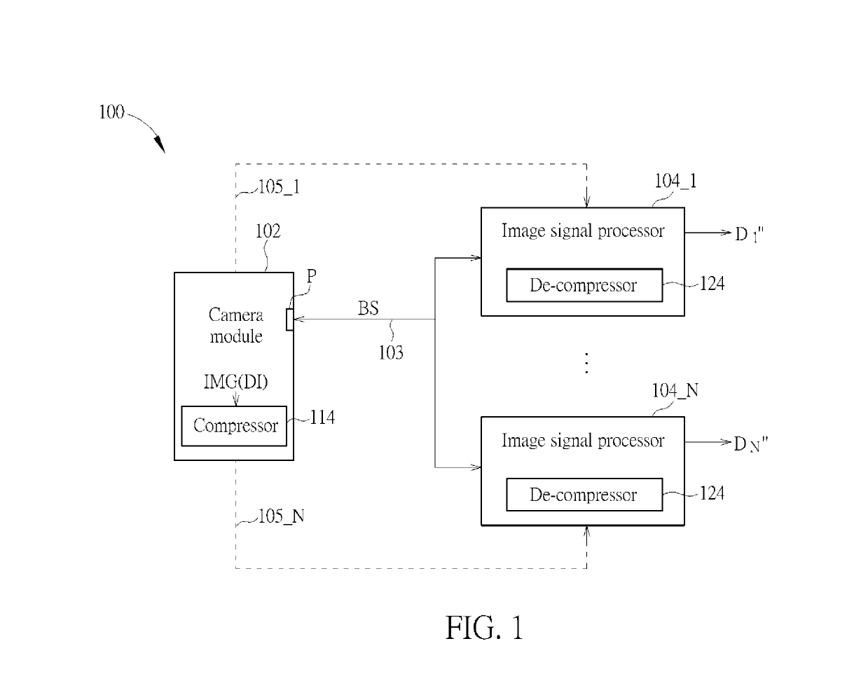

FIG. 1 is a block diagram illustrating a data processing system according to an embodiment of the present invention. The data processing system 100 includes a plurality of data processing apparatuses such as one camera module 102 and a plurality of image signal processors (ISPs) 104_1-104_N. Each of the image signal processors 104_1-104_N may be part of an application processor (AP). In this embodiment, the number of image signal processors 104_1-104_N depends on the actual camera resolution of the camera module 102. To alleviate the computing power requirement of the image signal processor, the image signal processors 104_1-104_N are used to process different image partitions of one picture in a parallel manner. In other words, each of the image signal processors 104_1-104_N is responsible for only processing a portion of one picture captured by the camera module 102, and therefore does not need to process all multimedia data of one complete picture.

The camera module 102 and the image signal processors 104_1-104_N may be implemented in different chips, and the camera module 102 may communicate with the image signal processors 104_1-104_N via a camera interface 103. In this embodiment, the camera interface 103 may be a camera serial interface (CSI) standardized by a Mobile Industry Processor Interface (MIPI). Each of the image signal processors 104_1-104_N receives the same compressed multimedia data of one picture IMG from the camera module 102. For one example, the bitstream BS may be an output bitstream transmitted from a single camera port P of the camera module 102 to respective image signal processors 104_1-104_N.

To achieve compressed data transmission over the camera interface 103, the camera module 102 supports data compression, and the image signal processors 104_1-104_N support data de-compression. Hence, the camera module 102 is configured to have one compressor 114 included therein, and each of the image signal processors 104_1-104_N is configured to have one de-compressor 124 included therein.

Concerning the camera module 102, it captures one picture IMG, generates a compressed multimedia data by compressing an input multimedia data derived from the picture IMG, and transmits the same compressed multimedia data to each of the image signal processors 104_1-104_N via the camera interface 103, where the picture IMG may be a single still image or may be one of successive images of a video sequence. In other words, the input multimedia data may be image data or video data that includes pixel data DI of a plurality of pixels of one picture IMG captured by the camera module 102.

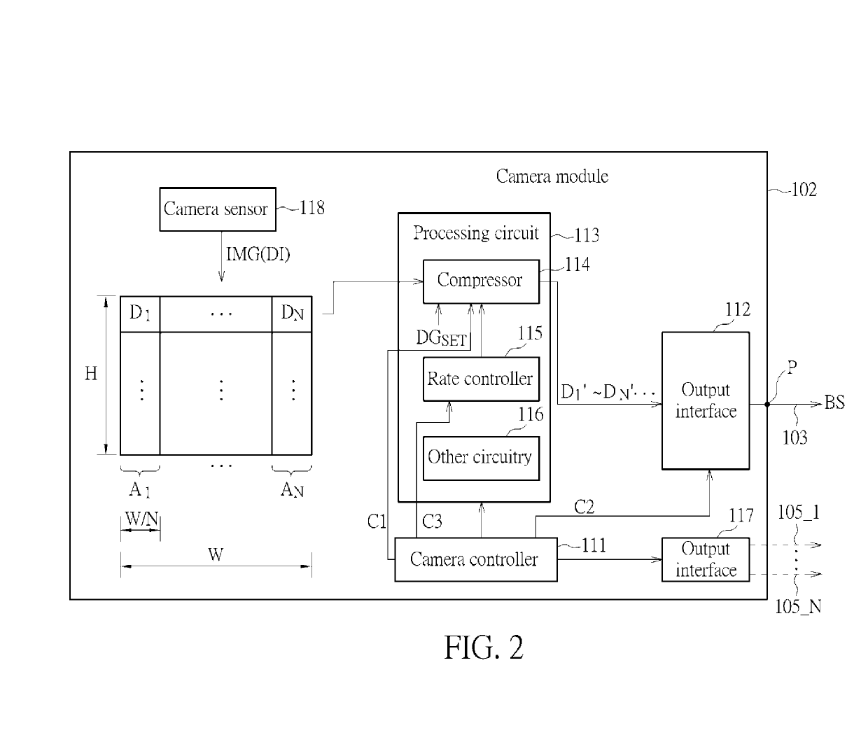

Please refer to FIG. 2, which is a diagram of the camera module 102 shown in FIG. 1 according to an embodiment of the present invention. The camera module 102 includes a camera controller 111, an output interface 112, a processing circuit 113, and a camera sensor 118. The camera sensor 118 is used to obtain an input multimedia data, including pixel data DI of a plurality of pixels of one picture IMG. As pixel data DI of pixels of the picture IMG is generated from the camera sensor 118, the pixel data format of each pixel depends on the design of the camera sensor 118. For example, when the camera sensor 118 employs a Bayer pattern color filter array (CFA) and performs demosaicing in RGB color space, each pixel may include one blue color component (B), one green color component (G), and one red color component (R). For another example, when the camera sensor 118 employs a Bayer pattern CFA and performs demo saicing in YUV color space, each pixel may include one luminance component (Y) and two chrominance components (U, V). It should be noted that this is for illustrative purposes only, and is not meant to be a limitation of the present invention. A skilled person should readily appreciate that the proposed random access capability enhancement technique of the present invention can be applied to pixel data DI in any pixel data format supported by the camera sensor 118.

The processing circuit 113 includes circuit elements required for processing the pixel data DI of the picture IMG. For example, the processing circuit 113 has the compressor 114, a rate controller 115 and other circuitry 116. The other circuitry 116 may have a camera buffer, multiplexer(s), etc. In one exemplary design, the camera buffer may be used to buffer the pixel data DI, and output the buffered pixel data DI to the compressor 114 through a multiplexer. In another exemplary design, the pixel data DI may bypass the camera buffer and enter the compressor 114 through the multiplexer. In other words, the pixel data DI to be processed by the compressor 114 may be directly provided from the camera sensor 118 or indirectly provided from the camera sensor 118 through the camera buffer.

The compressor 114 is configured to generate a plurality of compressed pixel data groups by compressing the pixel data DI of the picture IMG based on a pixel data grouping setting DG_{SET} of the picture IMG. By way of example, the pixel data grouping setting DG_{SET} is determined based on the number of image signal processors arranged for processing different image partitions of the picture IMG. Specifically, the camera controller 111 controls the operation of the camera module 102. Hence, the camera controller 111 may first check the number of enabled image signal processors coupled to the camera module 102, and then determine the pixel data grouping setting DG_{SET} in response to a checking result. For example, when receiving a query issued from the camera controller 111 of the camera module 102, each of the image signal processors 104_1-104_N implemented in the data processing system 100 generates an acknowledgement message to the camera controller 111. Thus, the camera controller 111 refers to the acknowledgement messages of the image signal processors 104_1-104_N to know that there are N enabled image signal processors 104_1-104_N coupled to the camera module 102. Since the image signal processors 104_1-104_N are used to process image contents of a plurality of image partitions in the same picture respectively, the pixel data grouping setting DG_{SET} corresponding to the exemplary arrangement of the image partitions A₁-A_{N} shown in FIG. 1 may be decided by the camera controller 111. That is, pixel data of pixels belonging to the image partition A₁ will be used for generating a compressed multimedia data designated to be processed by the image signal processor 104_1, and pixel data of pixels belonging to the image partition A_{N} will be used for generating a compressed multimedia data designated to be processed by the image signal processor 104_N. Hence, based on the pixel data grouping setting DG_{SET}, the compressor 114 knows the pixel boundary between pixel groups corresponding to different image partitions, and compresses pixel data of pixels in each pixel group (i.e., one pixel data group) into a compressed pixel data group.

As shown in FIG. 2, the width of the picture IMG is W, and the height of the picture IMG is H. Supposing that the image signal processors 104_1-104_N have the same computing power, the image partitions A₁-A_{N} may be set by the same size. Hence, each of the image partitions A₁-A_{N} has the same resolution of (W/N)xH. It should be noted that this is for illustrative purposes only. In an alternative design, the image signal processors 104_1-104_N may have different computing power, and the image partitions A₁-A_{N} may be set by different sizes. Moreover, horizontal image partitioning applied to the picture IMG is not meant to be a limitation of the present invention. In an alternative design, vertical image partitioning may be applied to the picture IMG, thus resulting in multiple image partitions arranged vertically in the picture IMG.

Concerning compression units (e.g., compression units each having X×Y pixels, where X may be 4 and Y may be 2) located at the same row, the pixel data of all pixels included in compression units corresponding to each image partition is compressed to generate a corresponding compressed pixel data group. For example, the pixel data of all pixels included in compression units corresponding to the image partition A₁ (i.e., pixel data group D₁) is compressed to generate a corresponding compressed pixel data group D₁′, and the pixel data of all pixels included in compression units corresponding to the image partition A_{N} (i.e., pixel data group D_{N}) is compressed to generate a corresponding compressed pixel data group D_{N}′. In other words, the compressor 114 generates compressed pixel data groups D₁′-D_{N}′ by compressing pixel data groups D₁-D_{N}, respectively.

The rate controller 115 is configured to apply bit-rate control to the compressor 114 for controlling a bit budget allocation per compression unit. In this way, each of the compressed pixel data groups (e.g., D₁′-D_{N}′) is generated at a desired bit rate. The output interface 112 is configured to pack/packetize compressed pixel data groups (e.g., D₁′-D_{N}′) into at least one output bitstream according to the transmission protocol of the camera interface 103, and transmit the at least one output bitstream to each of the image signal processors 104_1-104_N via the camera interface 103. By way of example, one bitstream BS may be generated from the camera module 102 to each of the image signal processors 104_1-104_N via one camera port P of the camera interface 103. The camera module 102 employs one of the proposed random access enhancement designs to make the compressed pixel data groups D₁′-D_{N}′ transmitted via the camera interface 103 become randomly accessible to each of the image signal processors 104_1-104_N. Further details of the proposed random access enhancement designs will be described later.

Please refer to FIG. 1 again. When the camera module 102 transmits compressed multimedia data to the image signal processors 104_1-104_N, each of the image signal processors 104_1-104_N is configured to receive the same compressed multimedia data from the camera interface 103, and only de-compress a portion of the randomly accessible compressed multimedia data (which is randomly accessible to each image signal processor due to using the proposed random access enhancement technique) to generate a de-compressed multimedia data corresponding to a portion of the picture IMG. For example, concerning compression units at the same row in the picture IMG, the camera module 102 generates compressed pixel data groups D₁′-D_{N}′ according to pixel data groups D₁-D_{N} belonging to different image partitions A₁-A_{N}. When receiving the compressed pixel data groups D₁′-D_{N}′ packed in an input bitstream (i.e., the bitstream BS generated from the camera module 102), the image signal processor 104_1 only generates and processes a de-compressed pixel data group D₁″ derived from de-compressing the compressed pixel data group D₁′ selected from the compressed pixel data groups D₁′-D_{N}′. Similarly, when receiving the compressed pixel data groups D₁′-D_{N}′ packed in an input bitstream (e.g., the bitstream BS generated from the camera module 102), the image signal processor 104_N only generates and processes a de-compressed pixel data group D_{N}″ derived from de-compressing the compressed pixel data group D_{N}_{N}′ selected from the compressed pixel data groups D₁′-D_{N}′.

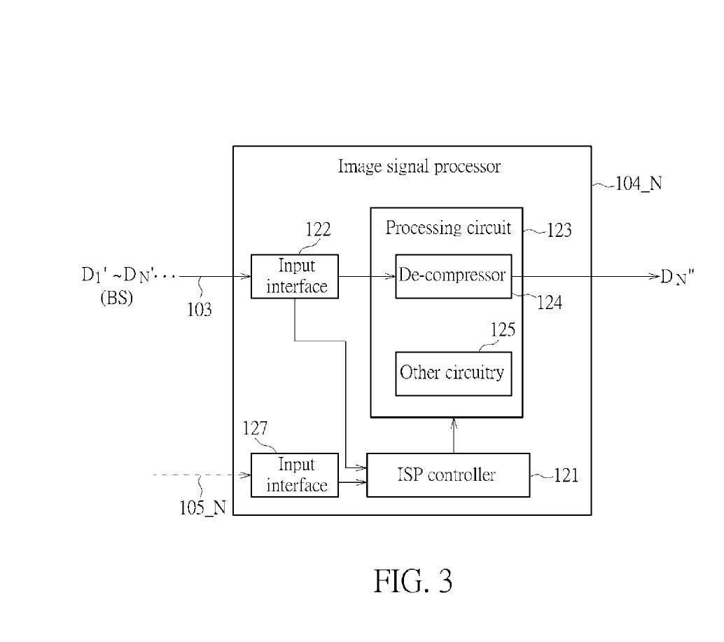

As shown in FIG. 1, each of the image signal processors 104_1-104_N communicates with the camera module 102 via the camera interface 103, and may have the same circuit configuration. For clarity and simplicity, only one of the image signal processors 104_1-104_N is detailed as below. Please refer to FIG. 3, which is a diagram illustrating the image signal processor 104_N shown in FIG. 1 according to an embodiment of the present invention. The image signal processor 104_N is coupled to the camera interface 103, and supports compressed data reception. In this embodiment, the image signal processor 104_N includes an ISP controller 121, an input interface 122 and a processing circuit 123. The input interface 122 is configured to receive an input bitstream from the camera interface 103 (e.g., the bitstream BS generated from the camera module 102), and un-pack/un-packetize the input bitstream into a plurality of compressed pixel data groups of one picture (e.g., compressed pixel data groups D₁′-D_{N}′ packed in the bitstream BS). It should be noted that, if there is no error introduced during the data transmission, the compressed pixel data groups un-packed/un-packetized from the input interface 122 should be identical to the compressed pixel data groups D₁′-D_{N}′ received by the output interface 112.

The ISP controller 121 is configured to control the operation of the processing circuit 123. The processing circuit 123 may include circuit elements required for deriving reconstructed multimedia data from the compressed multimedia data, and may further include other circuit element(s) used for applying additional processing to the reconstructed multimedia data. For example, the processing circuit 123 has a de-compressor 124 and other circuitry 125. The other circuitry 125 may have direct memory access (DMA) controllers, multiplexers, switches, an image processor, a camera processor, a video processor, a graphic processor, etc. In this embodiment, the ISP controller 121 is capable of detecting/deciding the boundary between any consecutive compressed pixel data groups un-packed from the input interface 122. Hence, concerning the compressed pixel data group D₁′-D_{N}′ un-packed from the input interface 122, the ISP controller 121 instructs the de-compressor 124 to de-compress one selected compressed pixel data group (e.g., D_{N}′) only and discard un-selected compressed pixel data groups (e.g., D₁′-D_{N-1}′). As mentioned above, each of the image signal processors 104_1-104_N is responsible for only processing one image partition of the picture IMG. Hence, with the help of the proposed random access capability enhancement technique, each of the image signal processors 104_1-104_N can identify and process a desired data portion in the received compressed multimedia data of the picture IMG in a random access manner, and discard the remaining data portions in the received compressed multimedia data of the picture IMG. Several random access capability enhancement techniques proposed by the present invention are described as below.

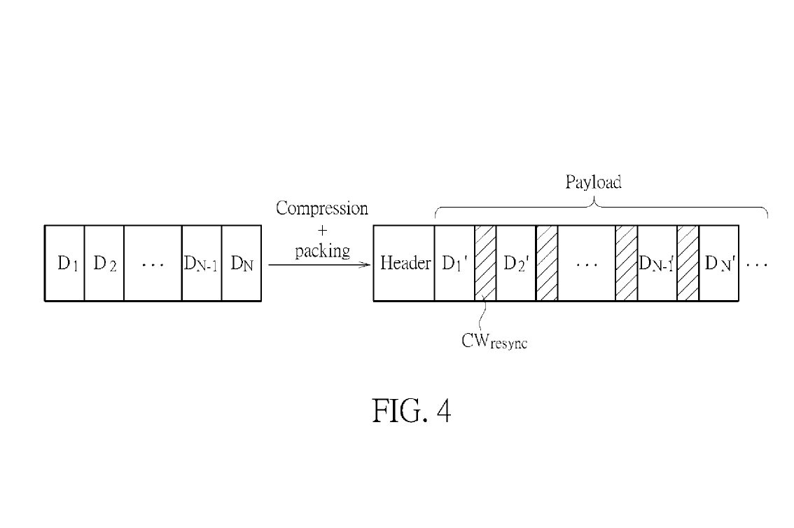

In one exemplary data processing system design with enhanced random access capability, the output interface 112 further records indication information in the output bitstream, wherein the indication information is indicative of at least one boundary each between two consecutive compressed pixel data groups packed in the output bitstream. In addition, the input interface 122 further parses indication information included in the input bitstream, wherein the indication information is indicative of at least one boundary each between two consecutive compressed pixel data groups packed in the input bitstream. In this embodiment, the indication information is transmitted through an in-band channel (i.e., camera interface 103). For example, the indication information may be recorded in a payload portion of the bitstream BS transmitted from the camera module 102 to each of the image signal processors 104_1-104_N. Please refer to FIG. 4, which is a diagram illustrating a first random access capability enhancement technique proposed by the present invention. The camera controller 111 shown in FIG. 2 generates a control signal C1 to the compressor 114 to enable insertion of one re-synchronization marker CW_{resync} between two compressed pixel data groups corresponding to different image partitions in the same picture IMG. As shown in FIG. 4, one re-synchronization marker CW_{resync} is inserted between the compressed pixel data groups D₁′ and D₂′, and one re-synchronization marker CW_{resync} is inserted between the compressed pixel data groups D_{N-1}′ and D_{N}′. The re-synchronization markers _{CWresync} serves as the aforementioned indication information recorded in the payload portion of the bitstream BS, and indicates the start of an independently decodable compressed pixel data group in the bitstream BS.

It should be noted that the re-synchronization markers CW_{resync} may be implemented using a unique codeword different from all possible payload codewords and all possible header syntax patterns that may be transmitted over the camera interface 103. Hence, when the bitstream BS with re-synchronization markers _{CWresync} properly inserted in the payload portion is received by one image signal processor (e.g., image signal processor 104_N), the input interface 122 is further configured to detect re-synchronization markers CW_{resync} and inform the ISP controller 121 of locations of the detected re-synchronization markers CW_{resync}. Based on the locations of the detected re-synchronization markers CW_{resync}, the ISP controller 121 knows the arrangement of compressed data partitions in the payload portion of the bitstream BS. Hence, after the compressed pixel data groups D₁′-D_{N}′ are sequentially un-packed/un-packetized from the bitstream BS, the ISP controller 121 determines the location of the desired compressed pixel data group D_{N}′ to be de-compressed, and instructs the de-compressor 124 to skip/discard compressed pixel data groups D₁′-D_{N-1}′ and directly de-compress the desired compressed pixel data group D_{N}′. With the help of the re-synchronization markers, the compressed pixel data groups can be randomly accessed by the image signal processors 104_1-104_N.

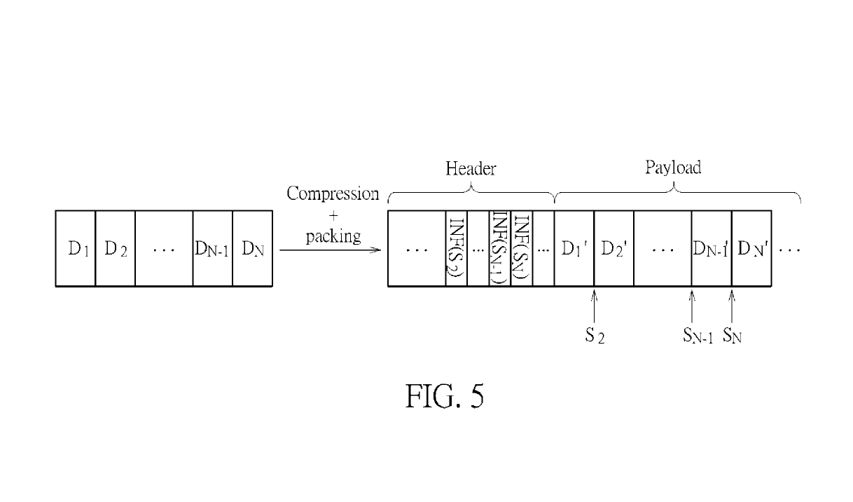

For another example, the indication information may be recorded in a header portion of the bitstream BS transmitted from the camera module 102 to each of the image signal processors 104_1-104_N. Please refer to FIG. 5, which is a diagram illustrating a second random access capability enhancement technique proposed by the present invention. The camera controller 111 shown in FIG. 2 generates a control signal C2 to the output interface 112 to enable transmission of boundary position information of two compressed pixel data groups corresponding to different image partitions in the same picture IMG. As shown in FIG. 5, the boundary position information INF(S₂) records a position S₂ of a boundary between consecutive compressed pixel data groups D₁′ and D₂′ packed in the bitstream BS, and the boundary position information INF(S_{N}) records a position S_{N} of a boundary between consecutive compressed pixel data groups D_{N-1}′ and D_{N}′ packed in the bitstream BS. The boundary position information INF(S₂)-INF(S_{N}) serves as the aforementioned indication information recorded in the header portion of the bitstream BS, and directly indicates the start of an independently decodable compressed pixel data group in the bitstream BS. Hence, when the bitstream BS with the boundary position information INF(S₂)-INF(S_{N}) properly included in the header portion is received by one image signal processor (e.g., image signal processor 104_N), the input interface 122 is further configured to inform the ISP controller 121 of the boundary position information INF(S₂)-INF(S_{N}) parsed from the bitstream BS. Based on the boundary locations, the ISP controller 121 knows the arrangement of compressed data partitions in the payload portion of the bitstream BS. Hence, after the compressed pixel data groups D₁′-D_{N}′ are sequentially un-packed/un-packetized from the bitstream BS, the ISP controller 121 determines the location of the desired compressed pixel data group D_{N}′ to be de-compressed, and instructs the de-compressor 124 to skip/discard compressed pixel data groups D₁′-D_{N-1}′ and directly de-compress the desired compressed pixel data group D_{N}′. With the help of the boundary position information, the compressed pixel data groups can be randomly accessed by the image signal processors 104_1-104_N.

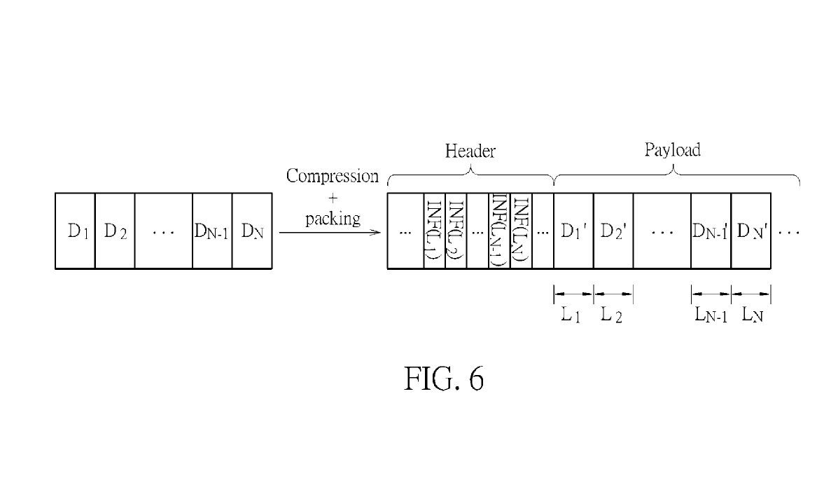

Using the boundary position information INF(S₂)-INF(S_{N}) to serve as the indication information recorded in the header portion of the bitstream BS transmitted via the camera interface 103 is merely one feasible implementation. Alternatively, the indication information recorded in the header portion of the bitstream BS transmitted via the camera interface 103 may be set by length information of compressed pixel data groups. Please refer to FIG. 6, which is a diagram illustrating a third random access capability enhancement technique proposed by the present invention. The camera controller 111 shown in FIG. 2 generates the control signal C2 to the output interface 112 to enable transmission of length information of compressed pixel data groups corresponding to different image partitions in the same picture IMG. As shown in FIG. 6, the length information INF(L₁) records a length L₁ of the compressed pixel data group D₁′ packed in the bitstream BS, the length information INF(L₂) records a length L₂ of the compressed pixel data group D₂′ packed in the bitstream BS, the length information INF(L_{N-1}) records a length L_{N-1} of the compressed pixel data group D_{N-1}′ packed in the bitstream BS, and the length information INF(L_{N}) records a length L_{N} of the compressed pixel data group D_{N}′ packed in the bitstream BS.

The length information INF(L₁)-INF(L_{N}) serves as the aforementioned indication information recorded in the header portion of the bitstream BS, and can be used to calculate the start of an independently decodable compressed pixel data group in the bitstream BS. That is, the boundary positions can be indirectly known based on the lengths of the compressed pixel data groups. Hence, when the bitstream BS with the length information INF(L₁)-INF(L_{N}) properly included in the header portion is received by one image signal processor (e.g., image signal processor 104_N), the input interface 122 is further configured to inform the ISP controller 121 of the length information INF(L₁)-INF(L_{N}) parsed from the bitstream BS. Based on lengths of compressed pixel data groups, the ISP controller 121 knows the arrangement of compressed data partitions in the payload portion of the bitstream BS. Hence, after the compressed pixel data groups D₁′-D_{N}′ are sequentially un-packed/un-packetized from the bitstream BS, the ISP controller 121 determines the location of the desired compressed pixel data group D_{N}′ to be de-compressed, and instructs the de-compressor 124 to skip/discard compressed pixel data groups D₁′-D_{N-1}′ and directly de-compress the desired compressed pixel data group D_{N}′. With the help of the length position information, the compressed pixel data groups can be randomly accessed by the image signal processors 104_1-104_N.

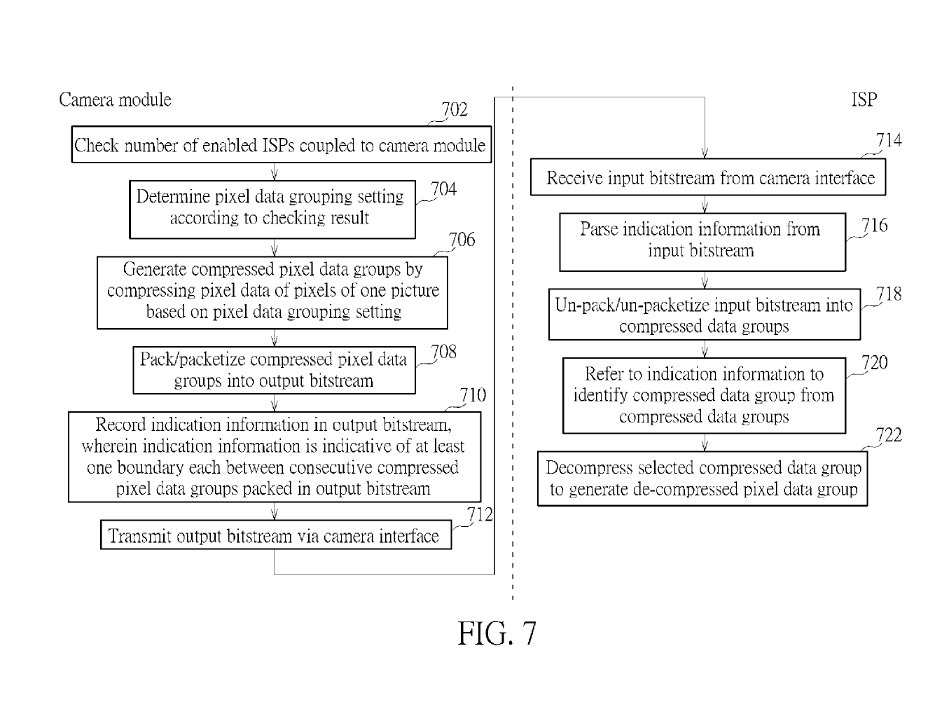

FIG. 7 is a flowchart illustrating one control and data flow of the data processing system 100 shown in FIG. 1 according to an embodiment of the present invention. Provided that the result is substantially the same, the steps are not required to be executed in the exact order shown in FIG. 7. The exemplary control and data flow may be briefly summarized by following steps.

Step 702: Check the number of enabled image signal processors coupled to a camera module.

Step 704: Determine a pixel data grouping setting according to a checking result. For example, when the checking result indicates that N image signal processors are enabled to process different image partitions of the same picture, the pixel data grouping setting may be determined based on the exemplary arrangement of image partitions A₁-A_{N} in the picture IMG, as shown in FIG. 1.

Step 706: Generate a plurality of compressed pixel data groups by compressing pixel data of a plurality of pixels of a picture based on the pixel data grouping setting of the picture.

Step 708: Pack/packetize the compressed pixel data groups into an output bitstream.

Step 710: Record indication information in the output bitstream, wherein the indication information is indicative of at least one boundary each between two consecutive compressed pixel data groups packed in the output bitstream. In one exemplary design, the indication information is recorded in a payload portion of the output bitstream. For example, the indication information includes one re-synchronization marker inserted between two consecutive compressed pixel data groups. In another exemplary design, the indication information is recorded in a header portion of the output bitstream. For example, the indication information may be boundary position information which records a position of each boundary between consecutive compressed pixel data groups packed in the output bitstream. For another example, the indication information may be length information which records a length of each compressed pixel data group packed in the output bitstream.

Step 712: Transmit the output bitstream via a camera interface.

Step 714: Receive an input bitstream from the camera interface.

Step 716: Parse the indication information from the input bitstream.

Step 718: Un-pack/un-packetize the input bitstream into a plurality of compressed data groups.

Step 720: Refer to the indication information to identify a compressed data group from the compressed data groups.

Step 722: Decompress the selected compressed data group to generate a de-compressed pixel data group.

It should be noted that steps 702-712 are performed by the camera module 102, and steps 714-722 are performed by one of the image signal processors 104_1-104_N. As a person skilled in the art can readily understand details of each step shown in FIG. 7 after reading above paragraphs, further description is omitted here for brevity.

In another exemplary data processing system design with enhanced random access capability, the camera module 102 may have another output interface (e.g., an output interface 117 in FIG. 2) configured to transmit indication information to each of the image signal processors 104_1-104_N via out-of-band channels 105_1-105_N, wherein the indication information is indicative of at least one boundary each between two consecutive compressed pixel data groups packed in the output bitstream transmitted via an in-band channel (i.e., camera interface 103). In addition, each image signal processor (e.g., the image signal processor 104_N in FIG. 3) has another input interface (e.g., an input interface 122 in FIG. 3) configured to receive indication information from a corresponding out-of-band channel (e.g., the out-of-band channel 105_N in FIG. 3), wherein the indication information is indicative of at least one boundary each between two consecutive compressed pixel data groups packed in the input bitstream received from the in-band channel (i.e., camera interface 103). For example, each of the out-of-band channels 105_1-105_N may be an I²C (Inter-Integrated Circuit) bus, the camera module 102 may be an I²C master device, and the image signal processors 104_1-104_N may be I²C slave devices. For another example, each of the out-of-band channels 105_1-105_N may be a control bus, such as a camera control interface (CCI), for MIPI's CSI interface.

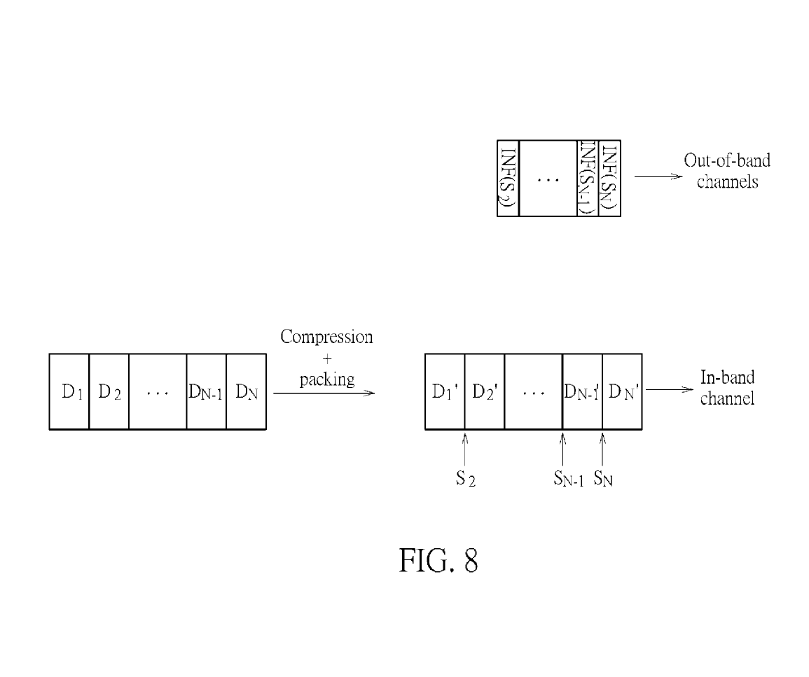

Please refer to FIG. 8, which is a diagram illustrating a fourth random access capability enhancement technique proposed by the present invention. The aforementioned boundary position information INF(S₂)-INF(S_{N}) is transmitted via each of the out-of-band channels 105_1-105_N. Hence, when boundary position information INF(S₂)-INF(S_{N}) is received by one image signal processor (e.g., image signal processor 104_N), the input interface 122 forwards the received boundary position information INF(S₂)-INF(S_{N}) to the ISP controller 121. Based on the boundary positions, the ISP controller 121 knows the arrangement of compressed data partitions in the payload portion of the bitstream BS. Hence, after the compressed pixel data groups D₁′-D_{N}′ are sequentially un-packed/un-packetized from the bitstream BS, the ISP controller 121 determines the location of the desired compressed pixel data group D_{N}′ to be de-compressed, and instructs the de-compressor 124 to skip/discard compressed pixel data groups D₁′-D_{N-1}′ and directly de-compress the desired compressed pixel data group D_{N}′.

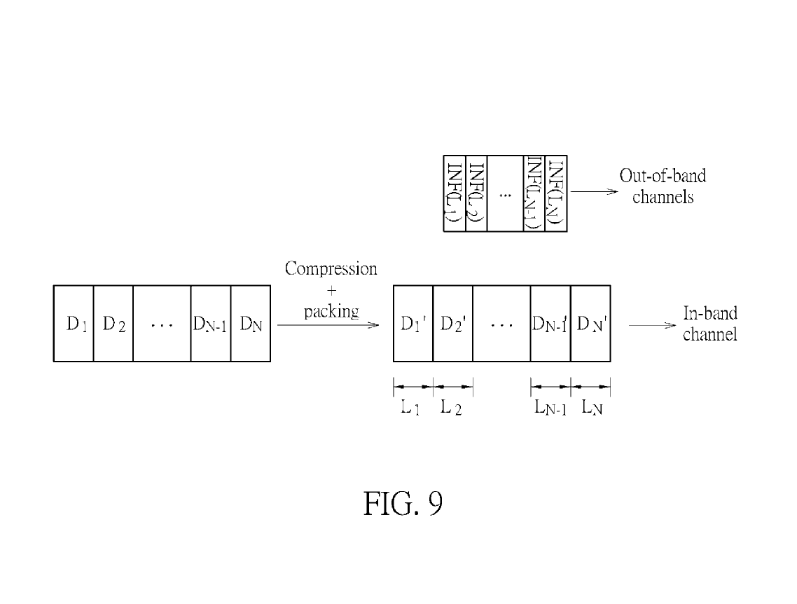

Please refer to FIG. 9, which is a diagram illustrating a fifth random access capability enhancement technique proposed by the present invention. The aforementioned length information INF(L₁)-INF(L_{N}) is transmitted via each of the out-of-band channels 105_1-105_N. Hence, when length information INF(L₁)-INF(L_{N}) is received by one image signal processor (e.g., image signal processor 104_N), the input interface 122 forwards the received length information INF(L₁)-INF(L_{N}) to the ISP controller 121. Based on lengths of compressed pixel data groups, the ISP controller 121 knows the arrangement of compressed data partitions in the payload portion of the bitstream BS. Hence, when the compressed pixel data groups D₁′-D_{N}′ are sequentially un-packed/un-packetized from the bitstream BS, the ISP controller 121 determines the location of the desired compressed pixel data group D_{N}′ to be de-compressed, and instructs the de-compressor 124 to skip/discard compressed pixel data groups D₁′-D_{N-1}′ and directly de-compress the desired compressed pixel data group D_{N′}.

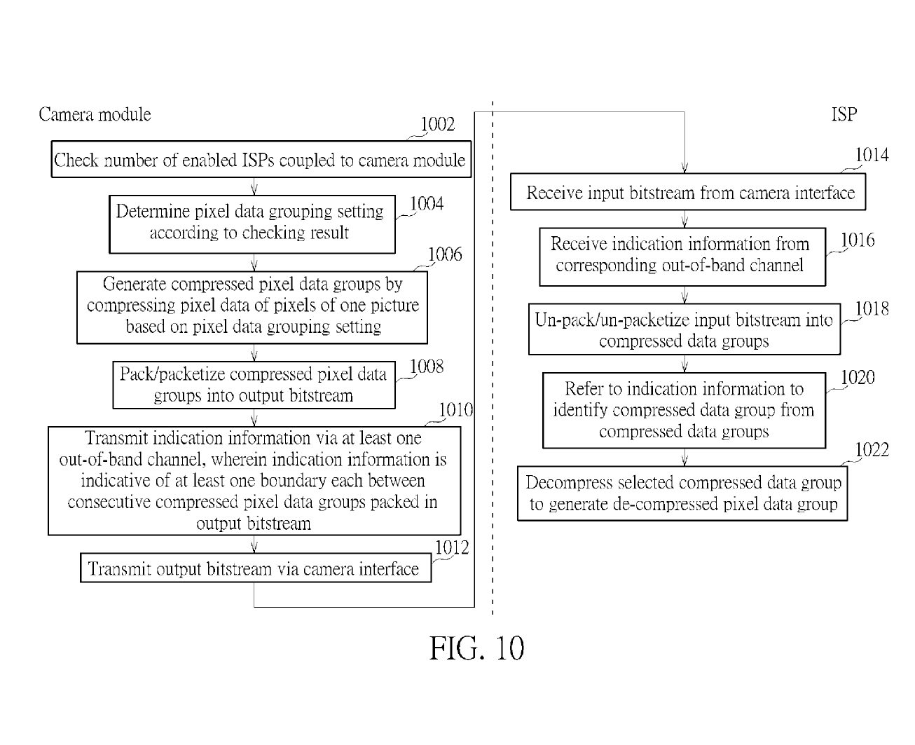

FIG. 10 is a flowchart illustrating another control and data flow of the data processing system 100 shown in FIG. 1 according to an embodiment of the present invention. Provided that the result is substantially the same, the steps are not required to be executed in the exact order shown in FIG. 10. The exemplary control and data flow may be briefly summarized by following steps.

Step 1002: Check the number of enabled image signal processors coupled to a camera module.

Step 1004: Determine a pixel data grouping setting according to a checking result. For example, when the checking result indicates that N image signal processors are enabled to process different image partitions of the same picture, the pixel data grouping setting may be determined based on the exemplary arrangement of image partitions A₁-A_{N} in the picture IMG, as shown in FIG. 1.

Step 1006: Generate a plurality of compressed pixel data groups by compressing pixel data of a plurality of pixels of a picture based on the pixel data grouping setting of the picture.

Step 1008: Pack/packetize the compressed pixel data groups into an output bitstream.

Step 1010: Transmit indication information via at least one out-of-band channel, wherein the indication information is indicative of at least one boundary between consecutive compressed pixel data groups packed in the output bitstream. For example, the indication information may be boundary position information which records a position of each boundary between consecutive compressed pixel data groups packed in the output bitstream. For another example, the indication information may be length information which records a length of each compressed pixel data group packed in the output bitstream.

Step 1012: Transmit the output bitstream via a camera interface.

Step 1014: Receive an input bitstream from the camera interface.

Step 1016: Receive the indication information from a corresponding out-of-band channel.

Step 1018: Un-pack/un-packetize the input bitstream into a plurality of compressed data groups.

Step 1020: Refer to the indication information to identify a compressed data group from the compressed data groups.

Step 1022: Decompress the selected compressed data group to generate a de-compressed pixel data group.

It should be noted that steps 1002-1012 are performed by the camera module 102, and steps 1014-1022 are performed by one of the image signal processors 104_1-104_N. As a person skilled in the art can readily understand details of each step shown in FIG. 10 after reading above paragraphs, further description is omitted here for brevity.

In yet another exemplary data processing system design with enhanced random access capability, the rate controller 115 is configured to ensure that at least a portion (i.e., part or all) of at least one of consecutive compressed pixel data groups packed in the output bitstream is generated under a fixed compression rate CR, where CR=Compressed data size/Uncompressd data size. In this embodiment, the camera module 102 may inform the image signal processors 104_1-104_N of the setting of fixed compression ratio CR through any feasible handshaking mechanism. Though a variable-length coding operation is applied to at least a portion (i.e., part or all) of a pixel data group, a rate-controlled compression result of at least a portion (i.e., part or all) of the pixel data group is ensured to have a known size due to the fixed compression ratio CR. In this way, the end of a corresponding compressed pixel data group derived from compressing the pixel data group can be determined based at least partly on the fixed compression ratio CR.

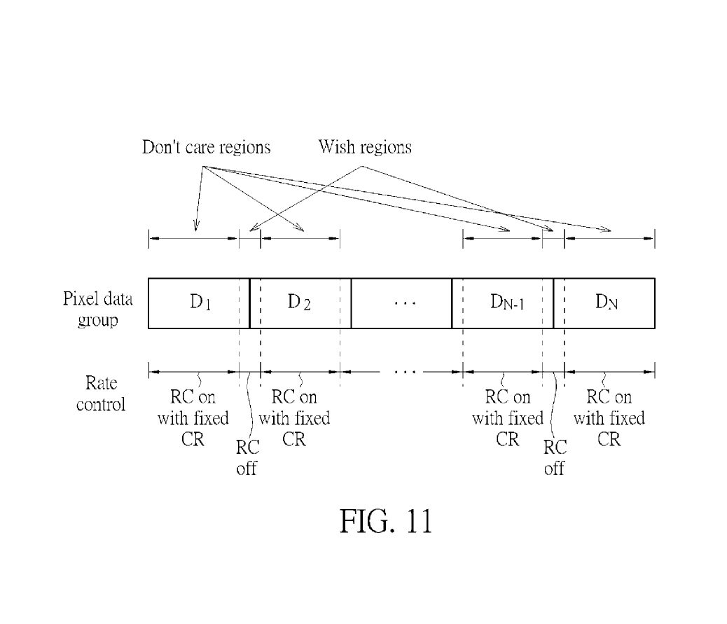

For example, the camera controller 111 shown in FIG. 2 may generate a control signal C3 to instruct the rate controller 115 to partially enable bit-rate control for compression of each pixel data group. Please refer to FIG. 11, which is a diagram illustrating a sixth random access capability enhancement technique proposed by the present invention. From the perspective of random access requirements, each pixel data group composed of pixel data of pixels belonging to one image partition in the picture IMG may be regarded as having a don't care region and a wish region, where a compression result of the don't care region does not need random access at the image signal processor side, and a compression result of the wish region needs random access at the image signal processor side. As can be seen from FIG. 11, the boundary between the pixel data groups D₁ and D₂ is also the boundary between wish regions of the pixel data groups D₁ and D₂, and the boundary between the pixel data groups D_{N-1} and D_{N} is also the boundary between wish regions of the pixel data groups D_{N-1} and D_{N}.

While the compressor 114 is compressing a don't care region of a pixel data group, the rate controller 115 enables bit-rate control RC with a fixed compression ratio CR. Hence, each of compression units in the don't care region may undergo variable-length coding, such that compression results of the compression units may have different lengths. Since compression results generated from compressing compression units in the don't care region have variable lengths, it is difficult to randomly access the compression results. However, an overall compressed data size of the don't care region would have a fixed value due to the fixed compression ratio CR well controlled by the rate controller 115. Hence, based on the fixed compression ratio CR, a boundary between a compression result of the don't care region and a compression result of the wish region can be easily known. While the compressor 114 is compressing a wish region of a pixel data group, the rate controller 115 disables bit-rate control RC. Each of compression units in the wish region may undergo fixed-length coding, such that compression results of the compression units may have the same length. Since compression results generated from compressing compression units in the wish region have fixed lengths that are known beforehand, it is easy to randomly access the compression results. Hence, the boundary between the consecutive compressed pixel data groups can be determined. That is, the start of an independently decodable compressed pixel data group in the bitstream BS can be identified.

When the bitstream BS with compressed pixel data groups, each generated by partially enabled rate control, is received by one image signal processor (e.g., image signal processor 104_N), the ISP controller 121 may refer to the fixed compression ratio CR and the fixed size of each pixel data group (which may also be informed by the camera module 102 through a handshaking mechanism) to know the arrangement of compressed data partitions in the payload portion of the bitstream BS. Hence, after the compressed pixel data groups D₁′-D_{N}′ are sequentially un-packed/un-packetized from the bitstream BS, the ISP controller 121 determines the location of the desired compressed pixel data group D_{N}′ to be de-compressed, and instructs the de-compressor 124 to de-compress the desired compressed pixel data group D_{N}′. With the help of the rate controller 115 that performs partially enabled rate control upon compression of each pixel data group to make a compression result of a portion of the pixel data group have a fixed compression ratio, the compressed pixel data groups can be randomly accessed by the image signal processors 104_1-104_N.

As mentioned above, compression results generated from compressing compression units in the wish region can be randomly accessed due to fixed-length coding. When performing de-compression upon a compressed pixel data group, the de-compressor of one image signal processor may retrieve and de-compress more compressed pixel data from wish region(s) of adjacent compressed pixel data group(s) for improving the image quality on the boundary of de-compressed pixel data groups. However, this is for illustrative purposes only, and is not meant to be a limitation of the present invention.

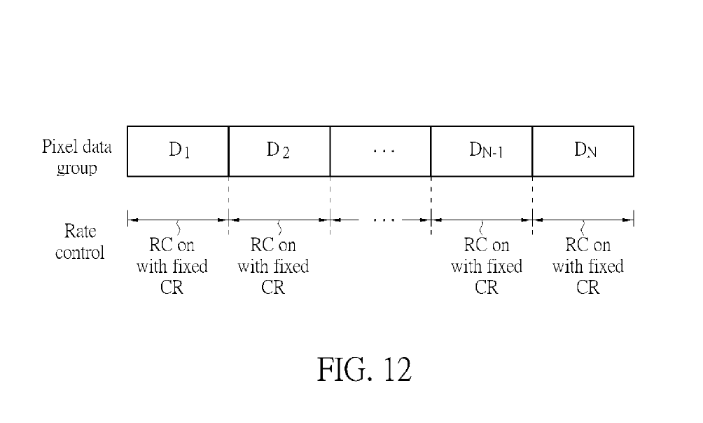

In an alternative design, the random access capability is available only for complete compressed pixel data groups. For example, the camera controller 111 generates the control signal C3 to instruct the rate controller 115 to completely enable bit-rate control for compression of each complete pixel data group. Please refer to FIG. 12, which is a diagram illustrating a seventh random access capability enhancement technique proposed by the present invention. From the perspective of random access requirements, each pixel data group composed of pixel data of pixels belonging to one image partition in the picture IMG may be regarded as having a don't care region only. As mentioned above, a compression result of the don't care region does not need random access at the image signal processor side.

While the compressor 114 is compressing each pixel data group, the rate controller 115 enables bit-rate control RC with a fixed compression ratio CR. Hence, each of compression units in a pixel data group may undergo variable-length coding, such that compression results of the compression units may have different lengths. However, an overall compressed data size of compression units in the pixel data group would have a fixed value due to the fixed compression ratio CR well controlled by the rate controller 115. Hence, fixed-sized compressed pixel data groups are generated from the compressor 114. Based on the fixed compression ratio CR, a boundary between consecutive compressed pixel data groups can be easily known. That is, the start of an independently decodable compressed pixel data group in the bitstream BS can be identified.

When the bitstream BS with compressed pixel data groups, each generated by completely enabled rate control, is received by one image signal processor (e.g., image signal processor 104_N), the ISP controller 121 may refer to the fixed compression ratio CR to know the arrangement of compressed data partitions in the payload portion of the bitstream BS. Hence, after the compressed pixel data groups D₁′-D_{N}′ are sequentially un-packed/un-packetized from the bitstream BS, the ISP controller 121 determines the location of the desired compressed pixel data group D_{N}′ to be de-compressed, and instructs the de-compressor 124 to skip/discard compressed pixel data groups D₁′-D_{N}′ and directly de-compress the desired compressed pixel data group D_{N}′. With the help of the rate controller 115 that performs completely enabled rate control upon compression of each pixel data group to make a corresponding compressed pixel data group have a fixed compression ratio, the compressed pixel data groups can be randomly accessed by the image signal processors 104_1-104_N.

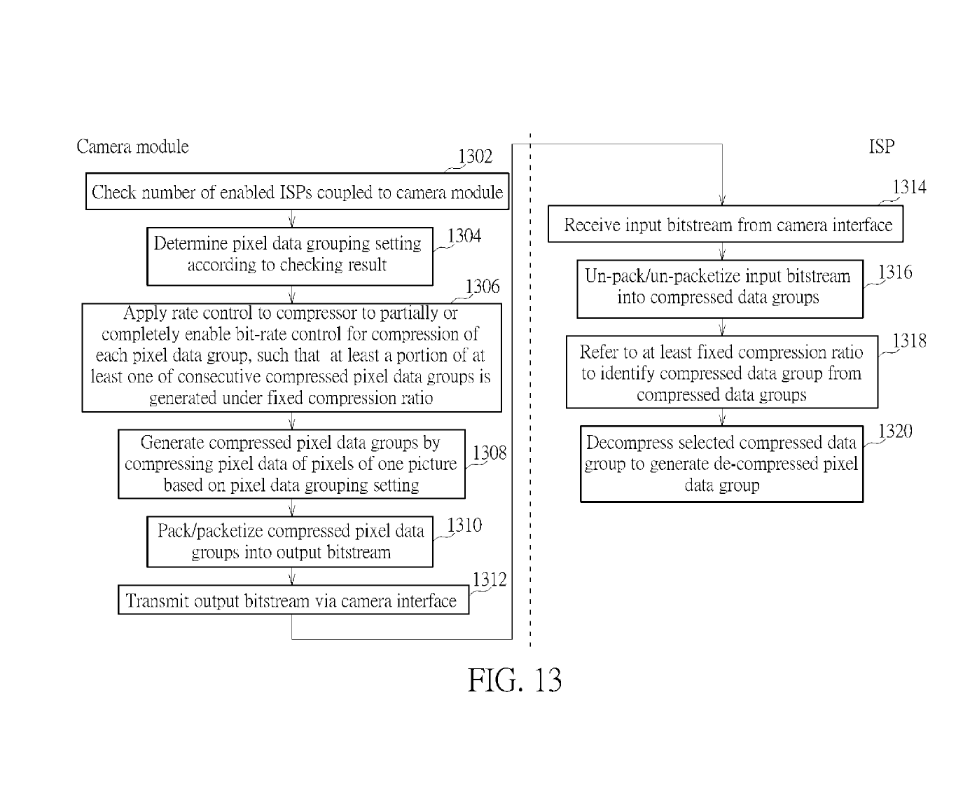

FIG. 13 is a flowchart illustrating yet another control and data flow of the data processing system 100 shown in FIG. 1 according to an embodiment of the present invention. Provided that the result is substantially the same, the steps are not required to be executed in the exact order shown in FIG. 13. The exemplary control and data flow may be briefly summarized by following steps.

Step 1302: Check the number of enabled image signal processors coupled to a camera module.

Step 1304: Determine a pixel data grouping setting according to a checking result. For example, when the checking result indicates that N image signal processors are enabled to process different image partitions of the same picture, the pixel data grouping setting may be determined based on the exemplary arrangement of image partitions A₁-A_{N} in the picture IMG, as shown in FIG. 1.

Step 1306: Apply rate control to a compressor to partially or completely enable bit-rate control for compression of each pixel data group, such that at least a portion (i.e., part or all) of at least one of consecutive compressed pixel data groups is generated under a fixed compression ratio.

Step 1308: Generate a plurality of compressed pixel data groups by compressing pixel data of a plurality of pixels of one picture based on the pixel data grouping setting of the picture.

Step 1310: Pack/packetize the compressed pixel data groups into an output bitstream.

Step 1312: Transmit the output bitstream via a camera interface.

Step 1314: Receive an input bitstream from the camera interface.

Step 1316: Un-pack/un-packetize the input bitstream into a plurality of compressed data groups.

Step 1318: Refer to at least the fixed compression ratio to identify a compressed data group from the compressed data groups.

Step 1320: Decompress the selected compressed data group to generate a de-compressed pixel data group.

It should be noted that steps 1302-1312 are performed by the camera module 102, and steps 1314-1320 are performed by one of the image signal processors 104_1-104_N. As a person skilled in the art can readily understand details of each step shown in FIG. 13 after reading above paragraphs, further description is omitted here for brevity.

With regard to the data processing system 100 shown in FIG. 1, the camera module 102 may employ one of the aforementioned random access capability enhancement techniques to enable an external circuit component (e.g., any of the image signal processors 104_1-104_N) to randomly access the compressed multimedia data. However, the same random access capability enhancement technique may be employed by a camera module to enable an internal circuit component (e.g., an output interface) to randomly access the compressed multimedia data.

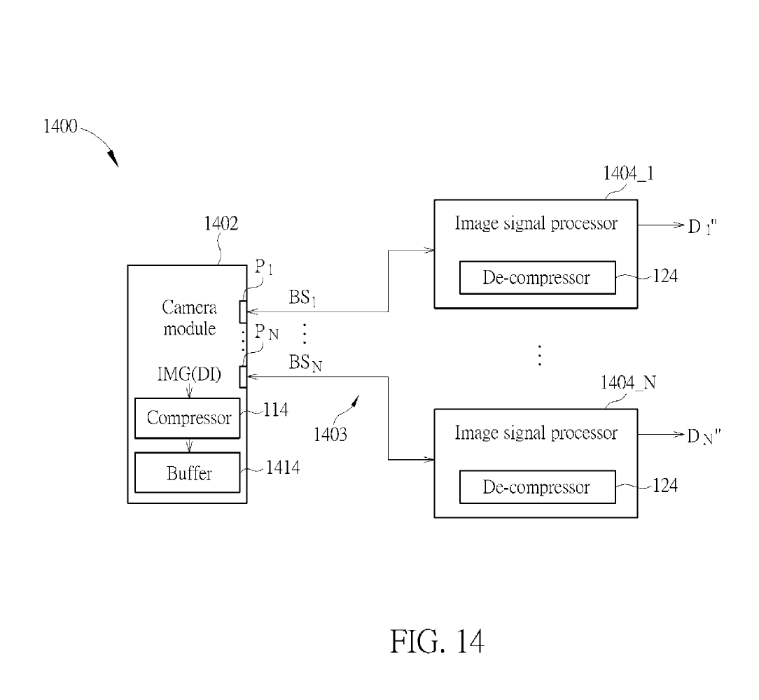

FIG. 14 is a block diagram illustrating another data processing system according to an embodiment of the present invention. The data processing system 1400 includes a plurality of data processing apparatuses such as one camera module 1402 and a plurality of image signal processors (ISPs) 1404_1-1404_N. Each of the image signal processors 1404_1-1404_N may be part of an application processor (AP). In this embodiment, the number of image signal processors 1404_1-1404_N depends on the actual camera resolution of the camera module 1402. The camera module 1402 and the image signal processors 1404_1-1404_N may be implemented in different chips, and the camera module 1402 may communicate with the image signal processors 1404_1-1404_N via a camera interface 1403. In this embodiment, the camera interface 1403 may be a camera serial interface (CSI) standardized by a Mobile Industry Processor Interface (MIPI).

To alleviate the bandwidth requirement of each camera port of the camera interface 1403, different image partitions of one picture are used to generate output bitstreams BS₁-BS_{N}, respectively; and the output bitstreams BS₁-BS_{N} are transmitted from the camera module 1402 to the image signal processors 1404_1-1404_N via multiple camera ports P₁-P_{N} of the camera interface 1403, respectively. Hence, the image signal processors 1404_1-1404_N are used to process different image partitions of one picture in a parallel manner. In other words, each of the image signal processors 1404_1-1404_N is responsible for only processing a portion of one picture captured by the camera module 102, and therefore does not need to process all multimedia data of one complete picture.

To achieve compressed data transmission over the camera interface 1403, the camera module 1402 supports data compression, and the image signal processors 1404_1-1404_N support data de-compression. Hence, the camera module 1402 is configured to have the aforementioned compressor 114 included therein, and each of the image signal processors 1404_1-1404_N is configured to have the aforementioned de-compressor 124 included therein.

One difference between the data processing systems 1400 and 100 is that the compressor 114 outputs the compressed multimedia data to a buffer 1414 for relaxing the real-time processing requirement. Another difference between the data processing systems 1400 and 100 is that the camera module 1402 reads the compressed multimedia data from the buffer 1414, and outputs different portions of the compressed multimedia data read from the buffer 1414 through multiple camera ports P₁-P_{N} of the camera interface 1403.

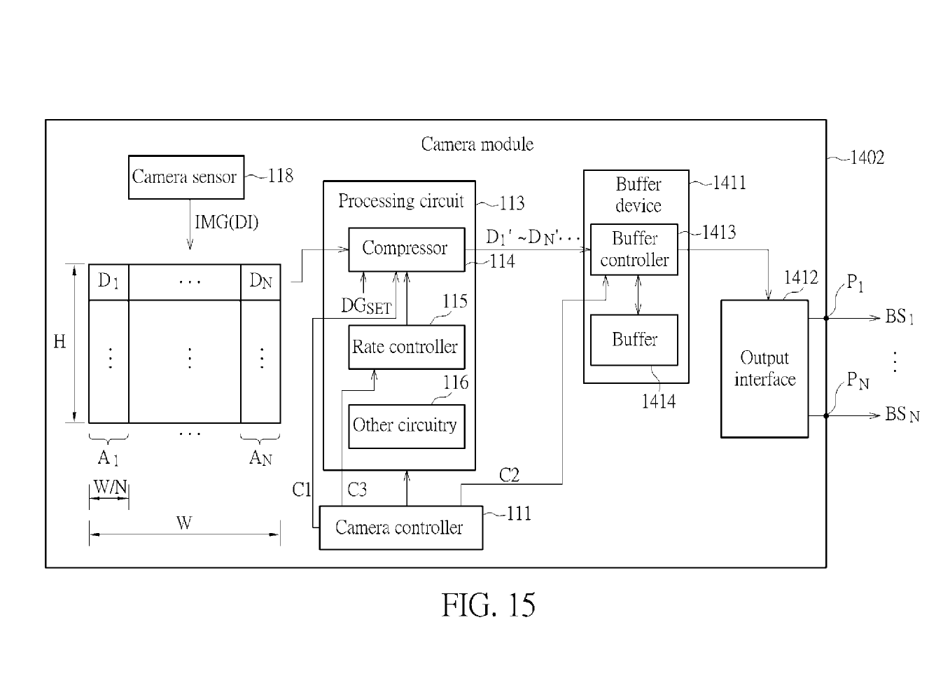

Please refer to FIG. 15, which is a diagram of the camera module 1402 shown in FIG. 14 according to an embodiment of the present invention. The camera module 1402 includes the aforementioned camera controller 111, processing circuit 113 and camera sensor 118, and further includes a buffer device 1411 and an output interface 1412. The buffer device 1411 includes a buffer controller 1413 and a buffer 1414. For example, the buffer 1414 may be a dynamic random access memory (DRAM), and the buffer controller 1413 may be a memory controller. As functions and operations of camera controller 111, processing circuit 113 and camera sensor 118 are detailed above, further description is omitted here for brevity. In this embodiment, the compressor 114 stores the compressed pixel data groups D₁′-D_{N}′ into the buffer 1414 through the buffer controller 1413, and the output interface 1412 reads the compressed pixel data groups D₁′-D_{N}′ from the buffer 1414 through the buffer controller 1413. The output interface 1412 is configured to pack/packetize compressed pixel data groups D₁′-D_{N}′ into output bitstreams BS₁-BS_{N} according to the transmission protocol of the camera interface 103, and transmit output bitstreams BS₁-BS_{N} to the image signal processors 1404_1-1404_N via camera ports P₁-P_{N}. Since the output interface 1412 needs to identify each of the compressed pixel data groups D₁′-D_{N}′ read from the buffer 1414, the camera module 1402 may employ one of the proposed random access enhancement designs to make the compressed pixel data groups D₁′-D_{N}′ become randomly accessible to the output interface 1412. For example, the buffer controller 1413 in the data processing system 1400 may play a role similar to that played by the output interface 112 in the data processing system 100, and the output interface 1412 in the data processing system 1400 may play a role similar to that played by each of the image signal processor 104_1-104_N in the data processing system 100.

In one exemplary data processing system design with enhanced random access capability, the output interface 1412 is configured to refer to indication information to identify a compressed pixel data group read from the buffer device 1414, pack/packetize the compressed pixel data into an output bitstream, and output the output bitstream to one of the image signal processors through one of the camera ports. For example, when the random access capability enhancement technique shown in FIG. 4 is employed by the camera module 1402, the camera controller 111 generates the control signal C1 to the compressor 114 to enable insertion of one re-synchronization marker CW resync between two compressed pixel data groups corresponding to different image partitions in the same picture IMG. After the compressed pixel data groups with re-synchronization markers CW resync properly inserted are stored into the buffer 1414 of the buffer device 1411, the output interface 1412 reads the buffered data from the buffer 1414, and detects re-synchronization markers CW_{resync} to know locations of the detected re-synchronization markers CW_{resync}. Based on the locations of the detected re-synchronization markers CW resync, the output interface 1412 knows the arrangement of compressed data in the buffer 1414, and therefore can identify each of the compressed data groups D₁′-D_{N}′ read from the buffer 1414. With the help of the re-synchronization markers, the compressed pixel data groups read from the buffer 1414 can be randomly accessed by the output interface 1412.

For another example, when the random access capability enhancement technique shown in FIG. 5 is employed by the camera module 1402, the camera controller 111 generates the control signal C2 to the buffer controller 1413 to enable transmission of boundary position information of two compressed pixel data groups corresponding to different image partitions in the same picture IMG. Hence, after the compressed pixel data groups D₁′-D_{N}′ with the boundary position information INF(S₂)-INF(S_{N}) properly created by the buffer controller 1413 are stored into the buffer 1414 of the buffer device 1411, the output interface 1412 reads the buffered data from the buffer 1414 to obtain the boundary position information INF(S₂)-INF(S_{N}). Based on the boundary locations, the output interface 1412 knows the arrangement of compressed data in the buffer 1414, and therefore can identify each of the compressed data groups D₁′-D_{N}′ read from the buffer 1414. With the help of the boundary position information, the compressed pixel data groups read from the buffer 1414 can be randomly accessed by the output interface 1412.

For yet another example, when the random access capability enhancement technique shown in FIG. 6 is employed by the camera module 1402, the camera controller 111 generates the control signal C2 to the buffer controller 1413 to enable transmission of length information of compressed pixel data groups corresponding to different image partitions in the same picture IMG. Hence, after the compressed pixel data groups D₁′-D_{N}′ with the length information INF(L₁)-INF(L_{N}) properly created by the buffer controller 1413 are stored into the buffer 1414, the output interface 1412 reads the buffered data from the buffer 1414 to obtain the length information INF(L₁)-INF(L_{N}). Based on lengths of compressed pixel data groups, the output interface 1412 knows the arrangement of compressed data buffered in the buffer 1414, and therefore can identify each of the compressed data groups D₁′-D_{N}′ read from the buffer 1414. With the help of the length position information, the compressed pixel data groups read from the buffer 1414 can be randomly accessed by the output interface 1412.

In another exemplary data processing system design with enhanced random access capability, the indication information indicative of at least one boundary each between two consecutive compressed pixel data groups may be transmitted to the output interface 1412 without stored into the buffer 1414. For example, when the random access capability enhancement technique shown in FIG. 8 is employed by the camera module 1402, the compressed pixel data groups D₁′-D_{N}′ are stored into the buffer 1414, and the boundary position information INF(S₂)-INF(S_{N}) is not stored into the buffer 1414. For example, the output interface 1412 may read the compressed pixel data groups D₁′-D_{N}′ from the buffer 1414 through an in-band path, and receives the boundary position information INF(S₂)-INF(S_{N}) generated by the buffer controller 1413 through an out-of-band path. For another example, when the random access capability enhancement technique shown in FIG. 9 is employed by the camera module 1402, the compressed pixel data groups D₁′-D_{N}′ are stored in to the buffer 1414, and the length information INF(L₁)-INF(L_{N}) is not stored into the buffer 1414. For example, the output interface 1412 may read the compressed pixel data groups D₁′-D_{N}′ from the buffer 1414 through an in-band path, and receives the length information INF(L₁)-INF(L_{N}) generated by the buffer controller 1413 through an out-of-band path.

In yet another exemplary data processing system design with enhanced random access capability, the output interface 1412 is configured to identify a compressed pixel data group read from the buffer 1414 according to a fixed compression ratio. For example, when the random access capability enhancement technique shown in FIG. 11 is employed by the camera module 1402, the camera controller 111 generates the control signal C3 to instruct the rate controller 115 to partially enable bit-rate control for compression of each pixel data group. After the compressed pixel data groups D₁′-D_{N}′, each generated by partially enabled rate control, are stored into the buffer 1414 of the buffer device 1411, the output interface 1412 may refer to the fixed compression ratio CR and the fixed size of each data group to know the arrangement of compressed data in the buffer 1414, and therefore can identify each of the compressed data groups D₁′-D_{N}′ read from the buffer 1414. With the help of the rate controller 115 that performs partially enabled rate control upon compression of each pixel data group to make a compression result of a portion of the pixel data group have a fixed compression ratio, the compressed pixel data groups read from the buffer 1414 can be randomly accessed by the output interface 1412.

For another example, when the random access capability enhancement technique shown in FIG. 12 is employed by the camera module 1402, the camera controller 111 generates the control signal C3 to instruct the rate controller 115 to instruct the rate controller 115 to completely enable bit-rate control for compression of each complete pixel data group. After the compressed pixel data groups D₁′-D_{N}′, each generated by completely enabled rate control, are stored into the buffer 1414, the output interface 1412 may refer to the fixed compression ratio CR to know the arrangement of compressed data in the buffer 1414, and therefore can identify each of the compressed data groups D₁′-D_{N}′ read from the buffer 1414. With the help of the rate controller 115 that performs completely enabled rate control upon compression of each pixel data group to make a corresponding compressed pixel data group have a fixed compression ratio, the compressed pixel data groups read from the buffer 1414 can be randomly accessed by the output interface 1412.

Please refer to FIG. 14 again. Each of the image signal processors 1404_1-1404_N is responsible for only processing one image partition of the picture IMG. Hence, the output interface 1412 outputs a portion of the compressed data of the picture IMG to one image signal processor, and the image signal processor generates a de-compressed multimedia data corresponding to a portion of the picture IMG. For example, concerning compression units at the same row in the picture IMG, the camera module 102 generates compressed pixel data groups D₁′-D_{N}′ according to pixel data groups D₁-D_{N} belonging to different image partitions A₁-A_{N}. When receiving the compressed pixel data group D₁′ packed in an input bitstream (i.e., the bitstream BS₁ generated from the camera module 1402), the image signal processor 1404_1 generates and processes a de-compressed pixel data group D₁″ derived from de-compressing the compressed pixel data group D₁′. Similarly, when receiving the compressed pixel data group D_{N}′ packed in an input bitstream (e.g., the bitstream BS_{N} generated from the camera module 1402), the image signal processor 1404_N generates and processes a de-compressed pixel data group D_{N}″ derived from de-compressing the compressed pixel data group D_{N}′.

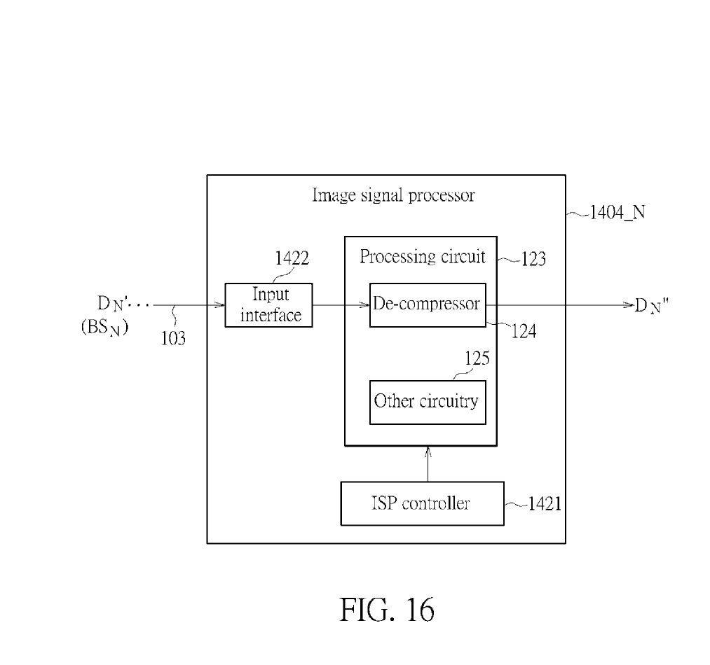

As shown in FIG. 14, each of the image signal processors 1404_1-1404_N communicates with the camera module 1402 via the camera interface 103, and may have the same circuit configuration. For clarity and simplicity, only one of the image signal processors 1404_1-1404_N is detailed as below. Please refer to FIG. 16, which is a diagram illustrating the image signal processor 1404_N shown in FIG. 14 according to an embodiment of the present invention. The image signal processor 1404_N is coupled to the camera interface 103, and supports compressed data reception. In this embodiment, the image signal processor 1404_N includes an ISP controller 1421, an input interface 1422 and the aforementioned processing circuit 123. The difference between the image signal processors 104_N and 1404_N is that the input interface 1422 receives the compressed pixel data group D_{N}′ rather than all of the compressed pixel data groups D₁′-D_{N}′. Hence, the ISP controller 1421 does not need to instruct the de-compressor 124 to skip/discard compressed pixel data groups D₁′-D_{N}′. As a person skilled in the art can readily understand function and operation of the image signal processor 1404_N after reading above paragraphs directed to the image signal processor 104_N, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

1. A data processing apparatus, comprising:
a compression circuit, configured to generate a plurality of compressed pixel data groups by compressing pixel data of a plurality of pixels of a picture based on a pixel data grouping setting of the picture, and generate indication information indicative of at least one boundary each between consecutive compressed pixel data groups; and
a first output interface, configured to pack the compressed pixel data groups into at least one output bitstream, and output the at least one output bitstream via a camera interface.

2. The data processing apparatus of claim 1, wherein the camera interface is a camera serial interface (CSI) standardized by a Mobile Industry Processor Interface (MIPI).

3. The data processing apparatus of claim 1, wherein the indication information includes a re-synchronization marker inserted between consecutive compressed pixel data groups.

4. The data processing apparatus of claim 1, wherein the indication information includes a position of each of the at least one boundary.

5. The data processing apparatus of claim 1, wherein the indication information includes a length of at least one of the consecutive compressed pixel data groups.

6. The data processing apparatus of claim 1, wherein the data processing apparatus further comprises:
a controller, configured to check a number of another data processing apparatuses coupled to the data processing apparatus via the camera interface, and determine the pixel data grouping setting of the picture in response to a checking result.

7. The data processing apparatus of claim 1, wherein the first output interface packs the compressed pixel data groups into an output bitstream, records the indication information in the output bitstream, and outputs the output bitstream with the indication information included therein via the camera interface.

8. The data processing apparatus of claim 7, wherein the indication information is recorded in a payload portion of the output bitstream.

9. The data processing apparatus of claim 7, wherein the indication information is recorded in a header portion of the output bitstream.

10. The data processing apparatus of claim 1, further comprising:
a second output interface, configured to transmit the indication information via an out-of-band channel.

11. The data processing apparatus of claim 10, wherein the out-of-band channel is a camera control interface (CCI) standardized by a Mobile Industry Processor Interface (MIPI).

12. The data processing apparatus of claim 1, further comprising:
a buffer device, configured to buffer the compressed pixel data groups generated from the compression circuit;
wherein the first output interface is further configured to refer to the indication information to identify a compressed pixel data group read from the buffer device.

13. A data processing apparatus, comprising:
a compression circuit, configured to generate a plurality of compressed pixel data groups by compressing pixel data of a plurality of pixels of a picture based on a pixel data grouping setting of the picture;
a rate controller, configured to perform bit rate control; and
an output interface, configured to pack the compressed pixel data groups into an output bitstream, and output the output bitstream via a camera interface;
wherein at least a portion of at least one of consecutive compressed pixel data groups is generated under a fixed compression ratio controlled by the rate controller.

14. The data processing apparatus of claim 13, wherein the camera interface is a camera serial interface (CSI) standardized by a Mobile Industry Processor Interface (MIPI).

15. The data processing apparatus of claim 13, wherein the data processing apparatus further comprises:
a controller, configured to check a number of another data processing apparatuses coupled to the data processing apparatus via the camera interface, and determine the pixel data grouping setting of the picture in response to a checking result.

16. The data processing apparatus of claim 13, further comprising:
a buffer device, configured to buffer the compressed pixel data groups generated from the compression circuit;
wherein the first output interface is further configured to identify a compressed pixel data group read from the buffer device according to the fixed compression ratio.

17. A data processing apparatus, comprising:
an input interface, configured to receive an input bitstream from a camera interface, un-pack the input bitstream into a plurality of compressed pixel data groups of a picture, and parse indication information included in the input bitstream, wherein the indication information is indicative of at least one boundary each between consecutive compressed pixel data groups packed in the input bitstream; and
a de-compressor, configured to refer to the indication information to select a compressed pixel data group from the compressed pixel data groups, and de-compress the compressed pixel data group to generate a de-compressed pixel data group.

18. The data processing apparatus of claim 17, wherein the camera interface is a camera serial interface (CSI) standardized by a Mobile Industry Processor Interface (MIPI).

19. The data processing apparatus of claim 17, wherein the indication information is recorded in a payload portion of the input bitstream.

20. The data processing apparatus of claim 19, wherein the indication information includes a unique re-synchronization marker inserted between the consecutive compressed pixel data groups.

21. The data processing apparatus of claim 17, wherein the indication information is recorded in a header portion of the input bitstream.

22. The data processing apparatus of claim 21, wherein the indication information includes a position of each of the at least one boundary.

23. The data processing apparatus of claim 21, wherein the indication information includes a length of at least one of the consecutive compressed pixel data groups.

24. A data processing apparatus, comprising:
a first input interface, configured to receive an input bitstream from a camera interface, and un-pack the input bitstream into a plurality of compressed pixel data groups of a picture;
a second input interface, configured to receive indication information from an out-of-band channel, wherein the indication information is indicative of at least one boundary each between consecutive compressed pixel data groups packed in the input bitstream; and
a de-compressor, configured to refer to the indication information to select a compressed pixel data group from the compressed pixel data groups, and de-compress the compressed pixel data group to generate a de-compressed pixel data group.

25. The data processing apparatus of claim 24, wherein the camera interface is a camera serial interface (CSI) standardized by a Mobile Industry Processor Interface (MIPI).

26. The data processing apparatus of claim 24, wherein the indication information includes a position of each of the at least one boundary.

27. The data processing apparatus of claim 24, wherein the indication information includes a length of at least one of the consecutive compressed pixel data groups.

28. A data processing apparatus, comprising:
an input interface, configured to receive an input bitstream from a camera interface, and un-pack the input bitstream into a plurality of compressed pixel data groups, wherein at least a portion of at least one of consecutive compressed pixel data groups packed in the input bitstream is generated under a fixed compression ratio; and
a de-compression circuit, configured to select a compressed pixel data group from the compressed pixel data groups according to at least the fixed compression ratio, and de-compress the compressed pixel data group to generate a de-compressed pixel data group.

29. The data processing apparatus of claim 28, wherein the camera interface is a camera serial interface (CSI) standardized by a Mobile Industry Processor Interface (MIPI).

30. A data processing method, comprising:
generating a plurality of compressed pixel data groups by compressing pixel data of a plurality of pixels of a picture based on a pixel data grouping setting of the picture;
generating indication information indicative of at least one boundary each between consecutive compressed pixel data groups; and
packing the compressed pixel data groups into at least one output bitstream, and outputting the at least one output bitstream via a camera interface.

31. A data processing method, comprising:
performing bit rate control;
generating a plurality of compressed pixel data groups by compressing pixel data of a plurality of pixels of a picture based on a pixel data grouping setting of the picture; and
packing the compressed pixel data groups into an output bitstream, and outputting the output bitstream via a camera interface;
wherein at least a portion of at least one of consecutive compressed pixel data groups is generated under a fixed compression ratio controlled by the bit rate control.

32. A data processing method, comprising:
receiving an input bitstream from a camera interface, un-packing the input bitstream into a plurality of compressed pixel data groups of a picture, and parsing indication information included in the input bitstream, wherein the indication information is indicative of at least one boundary each between consecutive compressed pixel data groups packed in the input bitstream; and
referring to the indication information to select a compressed pixel data group from the compressed pixel data groups, and de-compressing the compressed pixel data group to generate a de-compressed pixel data group.

33. A data processing method, comprising:
receiving an input bitstream from a camera interface, and un-packing the input bitstream into a plurality of compressed pixel data groups of a picture;
receiving indication information from an out-of-band channel, wherein the indication information is indicative of at least one boundary each between consecutive compressed pixel data groups packed in the input bitstream; and
referring to the indication information to select a compressed pixel data group from the compressed pixel data groups, and de-compressing the compressed pixel data group to generate a de-compressed pixel data group.

34. A data processing method, comprising:
receiving an input bitstream from a camera interface, and un-packing the input bitstream into a plurality of compressed pixel data groups, wherein at least a portion of at least one of consecutive compressed pixel data groups packed in the input bitstream is generated under a fixed compression ratio; and
selecting a compressed pixel data group from the compressed pixel data groups according to at least the fixed compression ratio, and de-compressing the compressed pixel data group to generate a de-compressed pixel data group.
